(19) United States
(12) Patent Application Publication
(10) Pub. No.: US 2025/0264737 A1
(43) Pub. Date: Aug. 21, 2025

(54) EYEWEAR WITH ANTI-NEAR-INFRARED RADIATION PROTECTION

(71) Applicant: Zenni Optical, Inc., Novato, CA (US)

(72) Inventors: Steven LEE, Barrington, IL (US); Sophia MOH, Daly City, CA (US); Morvari Ahi GOODYEAR, Danville, CA (US); Feng LIU, Zhenjiang (CN)

(21) Appl. No.: 19/054,688

(22) Filed: Feb. 14, 2025

Related U.S. Application Data
(60) Provisional application No. 63/554,921, filed on Feb. 16, 2024.
(60) Provisional application No. 63/634,928, filed on Apr. 17, 2024.

(51) Int. Cl. G02C 7/10

(52) U.S. Cl. CPC G02C 7/104

(57) ABSTRACT

Coating technologies, methods, and related products for providing protection against near-infrared radiation damage to a wearer's eyes are disclosed. For example, a lens can have a polymeric base material, an anti-near-infrared radiation coating disposed on the polymeric base material, and a top coating disposed on the anti-near-infrared radiation coating. The anti-near-infrared radiation coating can have at least six, seven, or eight layers of materials having varying layer thicknesses and provide superior reflection of near-infrared radiation while permitting transmission of visible light compared to traditional products and coatings.

### BACKGROUND

The present application claims the benefit of and priority to U.S. Provisional Application No. 63/554,921, filed on Feb. 16, 2024, and U.S. Provisional Application No. 63/634,928, filed on Apr. 17, 2024, the entireties of each of which are incorporated herein by reference.

### FIELD OF THE INVENTIONS

The present inventions relate to eyeglass lenses, and more specifically, to an eyeglass lens having a coating that can provide protection against near infrared radiation damage to a wearer's eyes.

### DESCRIPTION OF THE RELATED ART

Eyeglass lens coatings that offer protection against harmful rays from the sun have become increasingly crucial in the realm of eyewear technology. The need for such coatings arises from the growing awareness of the adverse effects of infrared radiation on ocular health and vision. For example, infrared radiation is known to cause a myriad of eye conditions, including cataracts, macular degeneration, and photokeratitis.

Infrared radiation coatings on eyewear have been utilized for several years, primarily for protection against infrared radiation exposure in certain occupational settings or for specialized activities such as welding. However, advancements in coating technologies have enabled the integration of infrared protection directly into sunglasses and prescription lenses, providing wearers with both vision correction and sun protection in a single product.

Early attempts at infrared protection coatings often involved simple tinting or surface treatments. Tinted lenses were effective at reducing visible light transmission, but they offered limited protection against specific wavelengths of infrared radiation. Moreover, these coatings were prone to scratching, peeling, and reduced optical clarity over time.

With advancements in materials science and optical engineering, modern eyeglass lens coatings have evolved to offer comprehensive infrared protection while maintaining optical clarity, durability, and aesthetics. Such coatings typically involve depositing specialized materials onto the lens surface through techniques such as vacuum deposition, ion-assisted deposition, or chemical vapor deposition.

One of the significant breakthroughs in eyeglass lens coatings is the development of multi-layered coatings that selectively filter out harmful UV rays while allowing beneficial visible light to pass through. These coatings often incorporate materials such as metal oxides, dyes, or nanoparticles, which exhibit precise control over the transmission spectrum.

### SUMMARY

The systems, methods, and devices of this disclosure are directed at various improvements for eyewear, namely multilayer coatings that more effectively reflect near infrared radiation and permit better transmission of visible light compared to conventional products. Some of the embodiments disclosed herein provide an innovative arrangement of materials that are layered and deposited at unique, specific thicknesses to achieve superior filtration infrared radiation and visible light that are not possible using conventional techniques and products.

In accordance with at least some embodiments disclosed herein is the realization that infrared radiation is harmful to the human eye, but near-infrared radiation, which has an approximate wavelength of between 700 nm and 2500 nm, is particularly harmful to the eye and can be responsible for several ocular maladies. For example, near-infrared radiation accounts for about 30% of sunlight and can penetrate the cornea, causing iris damage and vision loss. In severe cases, near-infrared short-wave radiation even causes retinal detachment and cataracts. Moreover, near-infrared radiation can easily penetrate the eyes and reach the retina. Consequently, near-infrared rays can directly cause fundus retinal burns. In severe cases, near-infrared radiation may cause atrophy of the macular part of the retina, which can lead to macular degeneration.

Additionally, in accordance with at least some embodiments disclosed herein is the realization that even though near-infrared radiation is very harmful to the human eye, it has a very similar wavelength range to visible light; therefore, the present disclosure is directed at systems, devices, and methods that can provide for a lens that reflects (i.e., blocks out) near-infrared radiation while permitting transmission (i.e., letting in) of visible light in order to obtain extremely beneficial protective results for the wearer. In accordance with some embodiments, a layered coating structure can be deposited onto a lens in order to enable selective reflection a substantial percentage of harmful near-infrared radiation while permitting transmission of most visible light. The results provided by such embodiments are far superior compared to traditional lens coatings and related products.

Further, in accordance with some embodiments, the inventors of the present disclosure have discovered specific layering profiles, compositional materials, layer thicknesses, and layering patterns that can produce a coating that can be configured to reflect and/or permit transmission of a near-infrared radiation and visible light using multilayer stacks of materials that successfully reflect more near infrared radiation and permit transmission of more visible light than prior technologies, which provides significant benefits in controlling visibility and brightness for lowlight conditions, controlling contrast, providing visual comfort, and controlling aesthetic coloration and design preferences for the lens. Stacking the layers optimizes the likelihood that any given wavelength range of near-infrared radiation will be reflected by the lens while still permitting visible light transmission through the lens.

Accordingly, aspects of this disclosure provide an eyeglass lens for providing protection against near infrared radiation damage to a wearer's eyes. The lens can have a polymeric base material, an anti-near-infrared radiation coating disposed on the polymeric base material that facilitates transmission of visible light while reflecting radiation in the near infrared region for protecting the wearer's eyes, and a top coating disposed on the anti-near-infrared radiation coating. The anti-near-infrared radiation coating can have a layered structure with multiple layers. For example, in some embodiments, the layered structure can comprise six, seven, eight, nine, or more layers.

In some embodiments, in a layered structure that has eight layers, each of the layers can be configured as follows. The first layer can be a silicon or metal oxide having a thickness of at least 130 nm. The second layer can be a metal oxide having a thickness of between about 1 nm and about 10 nm. The third layer can be a silicon or metal oxide having a thickness of less than 80 nm. The fourth layer can be a metal oxide having a thickness of at least 80 nm. The fifth layer can be a silicon or metal oxide having a thickness of at least 150 nm. The sixth layer can be a metal oxide having a thickness of at least 50 nm. The seventh layer can be a metal oxide having a thickness of between about 1 nm and about 10 nm. The eighth layer can be a silicon or metal oxide having a thickness of at least 40 nm.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology. Moreover, the systems, methods, and devices of this disclosure have several innovative aspects, no single one of which is solely responsible for the desirable attributes disclosed herein.

### BRIEF DESCRIPTION OF THE DRAWINGS

Various features of illustrative embodiments of the inventions are described below with reference to the drawings. The illustrated embodiments are intended to illustrate, but not to limit, the inventions. The drawings contain the following figures:

FIG. 1 illustrates various principles related to the energy, wavelength, and classification of the spectrum of radiation, including visible light, ultraviolet radiation, and infrared radiation.

FIG. 2 illustrates the spectrum of infrared radiation, which is classified as near infrared, mid infrared, or far infrared, depending on the wavelength.

FIGS. 3A-3C illustrate a lens with a layered coating structure, in accordance with some embodiments.

FIG. 4 illustrates the structure of the anti-near-infrared radiation coating, in accordance with some embodiments.

FIG. 5 illustrates the spectrum of radiation that is transmitted by the anti-near infrared lens, according to some embodiments.

FIG. 6 illustrates the spectrum of radiation that is reflected by the anti-near infrared lens, according to some embodiments.

### DETAILED DESCRIPTION

It is understood that various configurations of the subject technology will become readily apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for case of understanding.

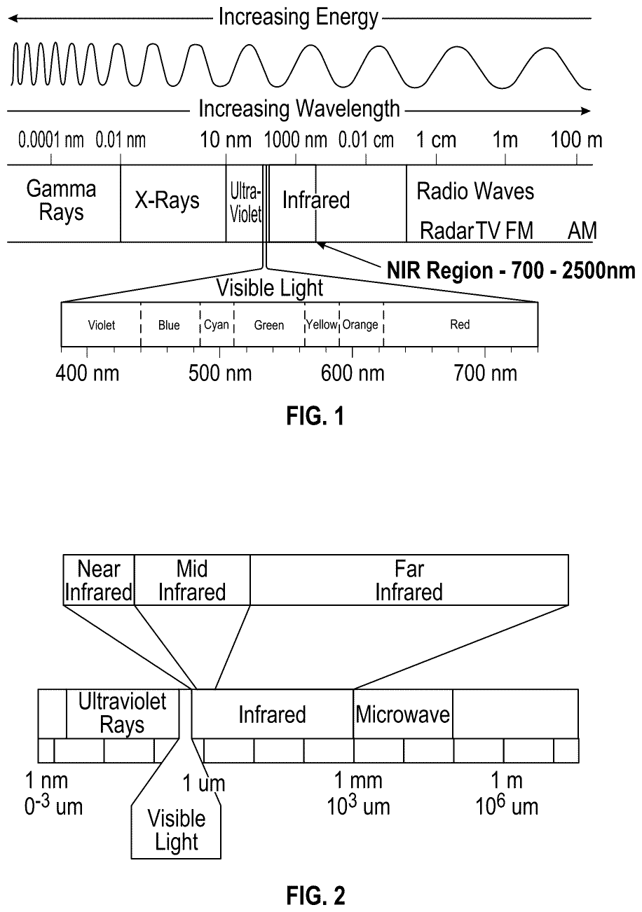

FIG. 1 illustrates various principles related to the energy, wavelength, and classification of the spectrum of radiation, including visible light, ultraviolet radiation, and infrared radiation. As illustrated, as the wavelength increases, the energy carried by the wave decreases. In practical terms, radiation having a larger wavelength represents a lower risk of causing damage to the eye. Conversely, shorter wavelength radiation represents a higher degree of potential damage to human tissue.

Referring still to FIG. 1, the visible light spectrum generally encompasses radiation having a wavelength that ranges from about 380 nm to about 750 nm. This is the range of radiation that must be permitted to transmit into the human eye in order for humans to see.

FIG. 2 illustrates the spectrum of infrared radiation, which is classified as near infrared, mid infrared, or far infrared, depending on the wavelength. Near-infrared radiation, which has the shortest wavelength of the three classes of infrared radiation, can have a wavelength of between about 700 nm and about 2500 nm. Mid-infrared radiation can have a wavelength of between about 2500 nm and 8000 nm. Far-infrared radiation, which has the longest wavelength and the least energy of the three classes of infrared radiation, can have a wavelength of between about 8000 nm and 15,000 nm.

As noted above, infrared radiation is harmful to the human eye. Exposure to infrared rays for 20 years or more increases a person's risk of having his or her vision reduced to 0.7 or less due to cataracts by a factor of 2.5 Similarly, exposure to infrared rays for 20 years or more increases a person's risk of having surgery for cataracts by a factor of 12. Of the three types of infrared radiation, near-infrared radiation is the most harmful to the human eye. Near-infrared radiation accounts for about 30% of sunlight and, especially the 780 nm to 1300 nm band of near-infrared radiation (known as the near-infrared short-wave radiation), can penetrate the cornea and cause iris damage and vision loss. In severe cases, near-infrared short-wave radiation can even cause retinal detachment and cataracts. Moreover, near-infrared radiation has strong penetrability and can reach the retina when irradiating the eyes. Near-infrared rays with a wavelength of approximately 1100 nm can directly cause fundus retinal burns without damaging the front media of the eye. In severe cases, near-infrared radiation may cause atrophy of the macular part of the retina, which can lead to macular degeneration.

Even though near-infrared radiation is the most harmful to the human eye, it is the closest (of the three types of infrared radiation) to visible light. While near-infrared radiation is harmful to humans because it is strongly absorbed by water, hemoglobin, and myoglobin, which helps it penetrate human tissue, visible light is crucial to humans' ability to see. Therefore, a lens that reflects (i.e., blocks out) near-infrared radiation while permitting transmission (i.e., letting in) of visible light is extremely beneficial to the wearer. Indeed, conventional technologies have fallen short in providing excellent optical properties due to the fact that near-infrared radiation and visible light have such similar wavelengths, making the reflection of near-infrared radiation difficult without also reflecting visible light.

However, in accordance with some embodiments disclosed herein, there are provided methods, systems, and devices that can integrate a layered coating structure onto a lens that facilitate the selectively reflection a substantial percentage of near-infrared radiation while permitting transmission of most visible light. Each layer of coating can reflect a different percentage of a different wavelength range of near-infrared radiation. The percentage and wavelength range of near-infrared radiation that is reflected by each layer may depend in part on the thickness of the layer, the material from which the layer is made, and the refraction index of the layer. Likewise, each layer of coating can permit transmission of a different percentage of a different wavelength range of visible light. Stacking layers of coating that target different reflection percentages and wavelength ranges of near-infrared radiation and visible light maximizes the reflection of harmful near-infrared radiation and the transmission of useful visible light by optimizing both the probability of near-infrared reflection at each layer and the probability of visible light transmission through the lens.

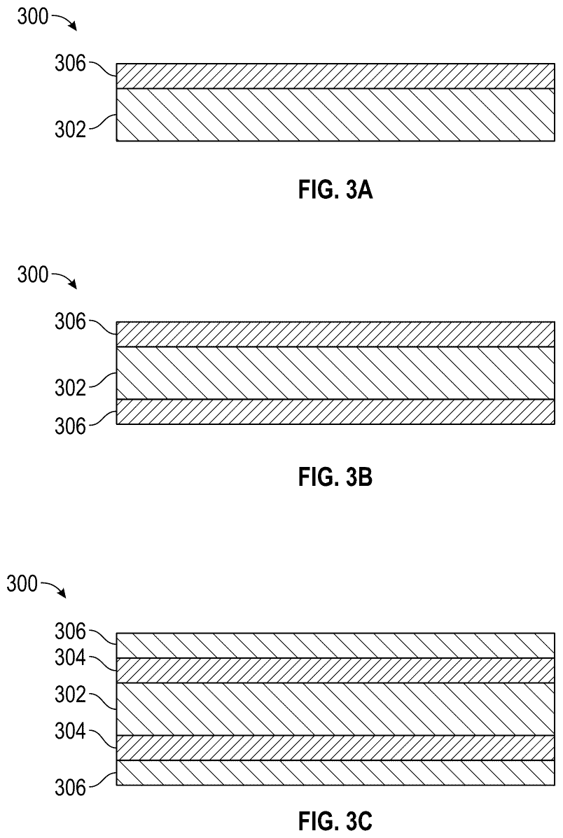

FIGS. 3A-3C illustrate a lens with a layered coating structure, in accordance with some embodiments. FIG. 3A shows a lens 300 with a base polymeric material 302 and an anti-near-infrared radiation coating 306. The lens 300 can either be a prescription lens or a non-prescription lens.

In FIG. 3A, the anti-near-infrared radiation coating 306 is deposited on an anterior surface of the base polymeric material 302. However, in some embodiments, the anti-near-infrared radiation coating 306 can be deposited on the posterior surface of the base polymeric material 302.

Further, the antiradiation coating 306 can also be deposited on both the anterior and the posterior surfaces of the base polymeric material 302. For example, FIG. 3B shows the anti-near-infrared radiation coating 306 on both the anterior and the posterior surfaces of the base polymeric material 302.

Optionally, the lens 300 can comprise a hard coating 304 on the outside of the base polymeric material 302, interposed between the base polymeric material 302 and the anti-near-infrared radiation coating 306, as shown in FIG. 3C. In some embodiments, the anti-near-infrared radiation coating 306 can be interposed between the base polymeric material 302 and the hard coating 304.

Moreover, in accordance with some embodiments, the anti-near-infrared radiation coating 306 can be deposited onto or underneath certain other functional coatings, such as a hard coating, an anti-dust coating, or a scratch-resistant coating. In some embodiments, the hard coating can have layers with thicknesses ranging from 3 nm to 170 nm.

In some embodiments, the anti-near-infrared radiation coating can comprise a plurality of layers. The layers can each have different thicknesses and be made of different materials, such that a given layer can be made of a different material than an adjacent layer.

In accordance with at least some embodiments disclosed herein is the realization that the anti-near-infrared radiation coating can have a material composition of each of its layers that provides unique and surprisingly effective interactions with others of the layers to permit higher reflection of unwanted radiation and higher transmission of visible light. The layers can be effective to filter or reflect photons of infrared radiation given their longer wavelengths and lower frequencies than photons of visible light. However, there been tremendous challenges associated with developing effective embodiments of the coatings disclosed herein, given the incredibly complex interactions of even a single, given layer with respective photons of infrared radiation and visible light, much less with multiple layers. The inventors of the present disclosure have found that the unpredictability of this area has led to surprising interactions and non-obvious innovations that far surpass the effectiveness of traditional technology in this area. Therefore, the various innovative arrangements, number of layers, arrangement of material compositions, layer thicknesses, and/or layer refraction indices disclosed herein provide far superior qualities compared to traditional techniques and products, as discussed further below.

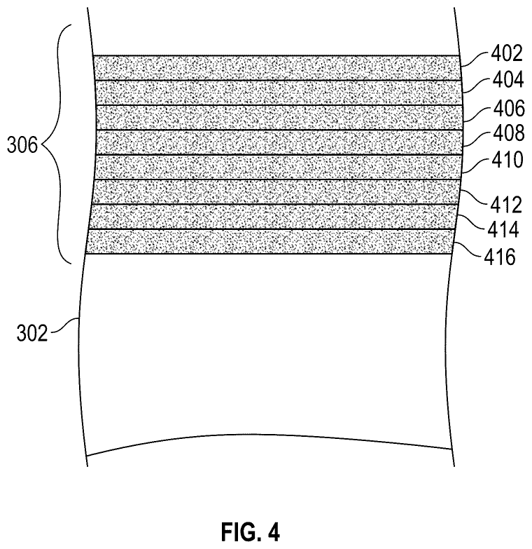

FIG. 4 illustrates the structure of the anti-near-infrared radiation coating, in accordance with some embodiments. As shown in FIG. 4, according to the illustrated embodiment, the structure of the anti-near-infrared radiation coating can comprise an eight-layer structure, with each layer having a variety of thicknesses, materials, and refraction indices as shown in Tables 1-3 below. However, the anti-near-infrared radiation coating can comprise at least five, six, seven, eight, nine, or more layers.

The anti-near-infrared radiation coating 306 can be configured such that the layers each comprise a thickness ranging from 3 nm to 170 nm. The cumulative thickness of the anti-near-infrared radiation coating 306, regardless of the number of layers of the anti-near-infrared radiation coating 306, can be at least 500 nm, 550 nm, 600 nm, or 650 nm, and in some embodiments, between about 500 nm and about 650 nm, between about 550 nm and about 640 nm, or between about 600 nm and about 630 nm.

In accordance with some embodiments, of the plurality of layers, some of the layers may have the same thickness. For example, two of the layers may comprise a thickness of about 6 nm. However, the layers may each have different or unique individual thicknesses. Further, the thickness of a given layer may be based on the desired optical qualities for that given layer.

Referring now to Table 1, some embodiments of the anti-near-infrared radiation coating can have an eight-layer structure with particular ranges of layer thicknesses for each of the layers in the eight-layer structure. However, the anti-near-infrared radiation coating can alternatively or in addition, be coated with a further coating to provide desirable additional properties for the lens, as discussed above.

A variety of thickness ranges are provided in Table 1, each of which can vary depending on the material implemented of the layer and/or the material, thickness, or other properties of an adjacent layer(s).

TABLE 1
Range of Thickness for Each Layer

| Layer | Layer Thickness |
|---|---|
| Layer (402) | 145 nm-170 nm |
| Layer (404) | 3 nm-10 nm |
| Layer (406) | 30 nm-40 nm |
| Layer (408) | 90 nm-120 nm |
| Layer (410) | 140 nm-160 nm |
| Layer (412) | 75 nm-110 nm |
| Layer (414) | 3 nm-10 nm |
| Layer (416) | 50 nm-80 nm |

The anti-near-infrared coating can comprise material(s) that provides advantageous properties in accordance with the configuration and design of the anti-near-infrared coating. For example, the anti-near-infrared coating can comprise any of a variety of inorganic oxides, including silicon dioxide (SiO₂), titanium dioxide (TiO₂), or indium tin oxide (ITO).

In accordance with some embodiments, of the plurality of layers, some of the layers may be made from the same material. For example, one or more of the layers may comprise silicon dioxide (SiO₂), titanium dioxide (TiO₂), or indium tin oxide (ITO).

Some embodiments of the hard coating and/or the anti-near-infrared radiation coating can be made from materials selected from the following group: Al₂O₃, MgF₂, TiO₂, ZnO, fluoropolymers, CeO₂, Si₃N₄, SiC, SnO₂, ITO, ZrO₂, Ta₂O₅, Nb₂O₅, Y₂O₃, BaF₂, La₂O₃, MnO₂, Ag, Cu, Au, organic polymers, and their equivalents.

Table 2 illustrates examples layer materials for each of the layers. The illustrated embodiment uses a combination of layers made from SiO₂, TiO₂, and ITO. Optionally, the anti-near-infrared radiation coating can be a top coating on the base polymeric material 302, as discussed above. However, the anti-near-infrared radiation coating can alternatively or in addition, be coated with a further coating to provide desirable additional properties for the lens, as discussed herein.

TABLE 2
Material for Each Layer

| Layer | Layer Material |
|---|---|
| Layer (402) | SiO₂ |
| Layer (404) | TiO₂ |
| Layer (406) | SiO₂ |
| Layer (408) | TiO₂ |
| Layer (410) | SiO₂ |
| Layer (412) | TiO₂ |
| Layer (414) | ITO |
| Layer (416) | SiO₂ |

In accordance with some embodiments, the anti-near-infrared radiation coating can be configured such that each of the layers has a desired refraction index. For example, one or more of the layers may comprise a refraction index of between about 1.1 to about 8, and in some embodiments, a refraction index of between about 1.3 to about 3, or a refraction index of between about 1.5 to about 2.2.

For example, the inventors have found exceptional properties with embodiments that use a refraction index for layer 404 of about 6.0, a refraction index for layer 406 of about 1.48, a refraction index for layer 408 of about 2.2, and a refraction index for layer 410 of about 1.5. However, variations on each of these refraction indices are contemplated and feasible, depending on layer thickness and material type.

For example, Table 3 illustrates example layer refraction indices for each of the layers in the eight-layer structure. The illustrated embodiment uses a combination of ranges of refraction indices.

However, the anti-near-infrared radiation coating 306 can alternatively or in addition, be coated with a further coating to provide desirable additional properties for the lens 300, as discussed herein.

TABLE 3
Range of Refraction Indices for Each Layer

| Layer | Layer Refraction Indices |
|---|---|
| Layer (402) | 1.3-1.6 |
| Layer (404) | 1.5-8 |
| Layer (406) | 1.3-1.6 |
| Layer (408) | 1.7-2.3 |
| Layer (410) | 1.3-1.7 |
| Layer (412) | 1.5-2.7 |
| Layer (414) | 1.6-2.5 |
| Layer (416) | 1.1-1.8 |

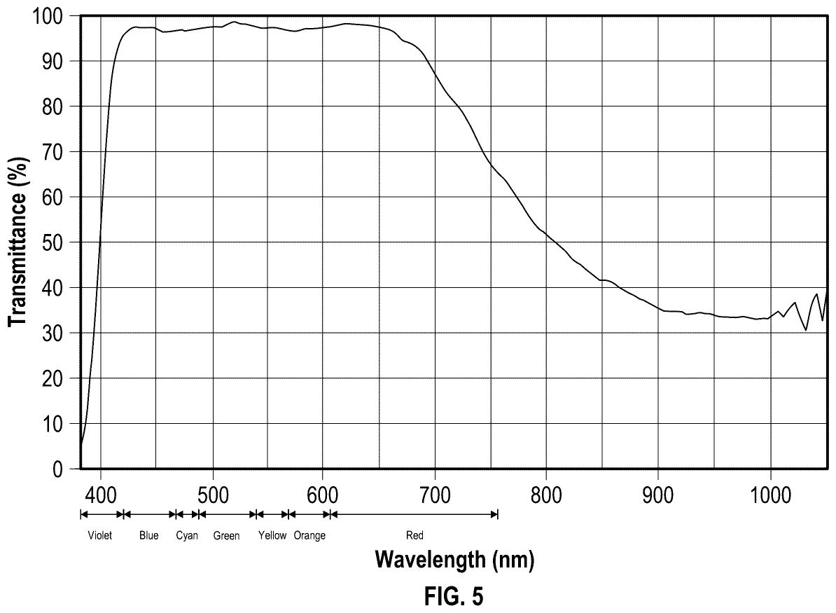

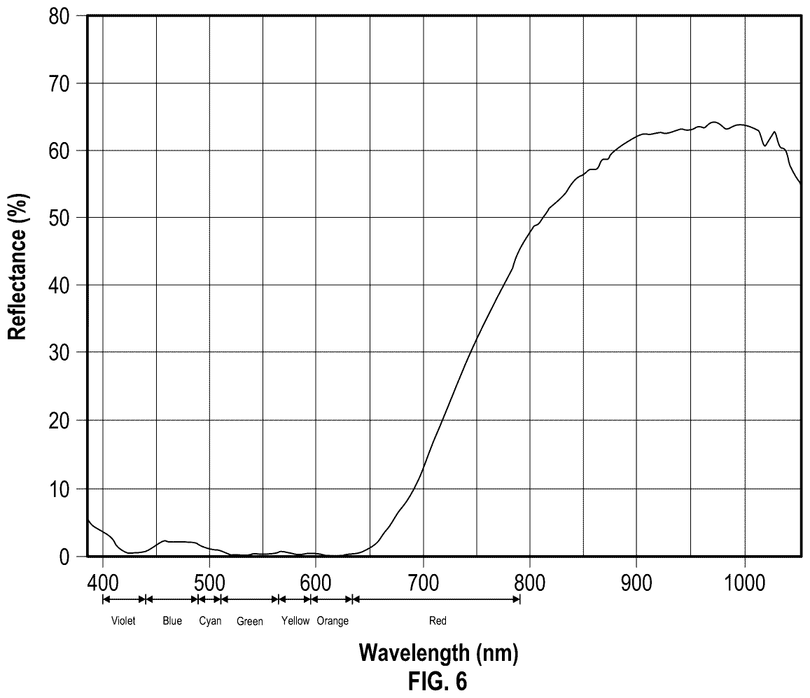

Table 4 provides details of a noteworthy embodiment found to achieve exceptional reflection of infrared radiation and transmission of visible light, as discussed further below with regard to FIGS. 5 and 6. As illustrated in Table 4, thicknesses, materials, and refraction indices for each layer of an embodiment of the anti-near-infrared radiation lens are provided the noteworthy embodiment. For example references, element numbers corresponding to FIG. 4 are also listed in Table 4; however, as discussed above, the general principles and disclosure related to FIG. 4 should not be limited to the values illustrated in Table 4. Instead, various embodiments can be successfully implemented using the above-noted principles and ranges disclosed in Tables 1-3.

TABLE 4
Thickness, Material, and Refraction Indices for Each Layer

| | | | | Layer |
|---|---|---|---|---|
| | Layer | | Layer | Refraction |
| Layer | Thickness | | Material | Indices |
| First SiO₂ Layer (402) | 150 | nm | SiO₂ | 1.486 |
| First TiO₂ Layer (404) | 6 | nm | TiO₂ | 6 |
| Second SiO₂ Layer (406) | 33 | nm | SiO₂ | 1.5 |
| Second TiO₂ Layer (408) | 105 | nm | TiO₂ | 2.2 |
| Third SiO₂ Layer (410) | 150 | nm | SiO₂ | 1.5 |
| Third TiO₂ Layer (412) | 90 | nm | TiO₂ | 2.23 |
| First ITO Layer (414) | 6 | nm | ITO | 2.055 |
| Fourth SiO₂ Layer (416) | 65 | nm | SiO₂ | 1.486 |

In accordance with at least some of the embodiments disclosed herein, the inventors have developed particularly effective coatings that provide cumulative refraction indices for the anti-near-infrared radiation coating of 1.50, 1.61, and 1.67. However, other cumulative refraction indices can be implemented in accordance with some embodiments.

Therefore, the principles, features, and techniques of the present disclosure can be implemented to coat a corrective or non-corrective lens in order to provide an anti-near-infrared radiation lens. The applications for such a lens can be wide-ranging, including traditional corrective eyewear, sports eyewear, and military eyewear, and single or dual lens eyeglasses, goggles, or headsets.

Referring now to FIGS. 5 and 6, a spectrum of radiation, including visible light and infrared radiation, can be transmitted to the anti-near-infrared radiation lens in use, and FIGS. 5 and 6 illustrate the exceptional performance of the presently disclosed anti-near-infrared radiation coating, according to some embodiments. Although the values are representative of the noteworthy anti-near-infrared radiation coating having the properties disclosed above in Table 5, these values are also representative of various other coatings that might be arranged or configured slightly differently than the noteworthy anti-near-infrared radiation coating.

As illustrated in FIG. 5, in the wavelength range of approximately 380 nm to 790 nm (i.e., the visible light spectrum), the lens 300 having the anti-near-infrared radiation coating disclosed herein permits transmission of an average of about 90%, such as up to 91%, 92%, or 93%, of visible spectrum rays. Additionally, the lens 300 permits transmission of light very consistently across the spectrum of visible light from approximately 420 nm to 650 nm, which is a dramatic and non-trivial improvement over lenses with a conventional coating, which tend to have substantial drops in transmission percentage around 480 nm, which is the blue portion of the visible light spectrum.

For example, if a percentage of visible light is blocked by a lens with a conventional coating, the wearer of the lens will perceive a reduced overall brightness of the transmitted light. This can affect visibility, especially in low-light conditions. Furthermore, a lens that blocks visible light can also alter the wearer's perception of color. Depending on the specific wavelengths blocked, the colors may appear shifted or muted. For example, if the coating primarily blocks blue light, objects may appear warmer or more yellowish. Finally, blocking certain wavelengths of light can also affect the contrast between different objects in the field of view. For example, if the coating blocks blue light, it may reduce the contrast between blue objects and their surroundings, making them appear less distinct.

According to some embodiments, the curve shown in the graph of FIG. 5 can be analyzed to calculate the percentage of visible light and near-infrared radiation that is transmitted by the lens 300. Such calculations obtain the area under the curve (transmitted visible light and transmitted near-infrared radiation) compared to the area above the curve (reflected visible light and reflected near-infrared radiation). These calculations demonstrate that compared to traditional coatings, the presently disclosed anti-near-infrared radiation coatings 306 can provide nearly equivalent transmission of visible light while reflecting at least 40%, 50%, 60%, 63%, or more of near-infrared radiation compared to traditional coatings, which only reflect between about 25% and 40% of near-infrared radiation. In other words, the presently disclosed embodiments can provide equivalent or better visible optical properties while protecting the wearer against far more near-infrared radiation than conventional coating technologies. These exceptional results are possible using the disclosed ranges and features, and combinations of the same, as provided in some embodiments herein.

In some embodiments, such exceptional results (compared to traditional technologies) were discovered by the present applicants through analyzing and comparing materials, thicknesses, and refraction indices of the multiple layers of the anti-near-infrared radiation coating, as well as the number of layers thereof. The surprising relationships and myriad interference/combination properties created through variations of these parameters led to discoveries that allowed the present applicants to achieve far superior reflection of near-infrared radiation while providing excellent visible light transmission.

For example, in accordance with some embodiments disclosed herein is the realization that certain combinations of material layers having certain thicknesses can create cumulative effects in reflecting near-infrared radiation and permitting transmission of visible light. For purposes of the present disclosure, these cumulative effects can be conceptualized as layer probabilities of reflection and transmission for radiation of a given wavelength. The discoveries and innovations of the present disclosure represent a substantial improvement over conventional coating technologies, as discussed herein.

In some embodiments of the anti-near-infrared radiation coating, the coating can comprise thinner layers (e.g., layers 404 and 406) between thicker layers (e.g., layers 402, 408, and 410) to permit the near-infrared radiation that reflects off either side of the thinner layers to destructively interfere with itself and near-infrared radiation reflected from other layers-thereby blocking near-infrared radiation while allowing visible light to be transmitted through the lens 300. Likewise, providing layers with lower refractive indices (e.g., layers 410) between layers with higher refractive indices (e.g., layers 408, 412, and 414) can permit the near-infrared radiation that reflects off the multiple layers of the anti-near-infrared radiation coating 306 constructively interfere with itself to maximize reflection of near-infrared radiation.

Referring now to FIG. 6, a curve is shown that illustrates the spectrum of radiation that is reflected by the lens 300, which includes the anti-near-infrared radiation coating 306, according to some embodiments.

According to some embodiments, the curve shown in the graph of FIG. 5 can be analyzed to calculate the percentage of visible light and near-infrared radiation reflected by the lens 300. Such calculations obtain the area under the curve (reflected visible light and reflected near-infrared radiation) compared to the area above the curve (transmitted visible light and transmitted near-infrared radiation). These calculations demonstrate that the lens 300 reflects at least about 60%, and in some embodiments, at least about 63% of near-infrared radiation with wavelengths of 790 nm to 1050 nm. This is a drastic improvement over lenses that utilize conventional coatings, which can only reflect up to about 25% to about 40% of near-infrared radiation in a similar wavelength range. Accordingly, the lens 300 can reflect between about 50% to about 250% more near-infrared radiation in the 790 nm to 1050 nm wavelength range than lenses with conventional coatings.

Therefore, the innovations of the present disclosure enable lenses, such as the lens 300, to reflects vastly more near-infrared radiation without reflecting any more visible light, when compared to conventional lens coatings. These incredible results demonstrate the inventiveness and significant innovation that underlies the embodiments disclosed herein. Thus, anti-near-infrared radiation lens coatings according to the present disclosure can be up to 240% more effective at reflecting near-infrared radiation than lenses with conventional coatings while maintaining approximately the same thickness as lenses with conventional coatings.

### Illustration of Subject Technology as Clauses

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1. An eyeglass lens for providing protection against near infrared radiation damage to a wearer's eyes, the lens comprising: a polymeric base material; an anti-radiation coating disposed on the polymeric base material, the anti-radiation coating comprising a layered structure of a first SiO₂ layer, a first TiO₂ layer, a second SiO₂ layer, a second TiO₂ layer, a third SiO₂ layer, a third TiO₂ layer, a first ITO layer, and a fourth SiO₂ layer, the anti-radiation coating being configured to facilitate transmission of visible light while reflecting radiation in the near infrared region for protecting the wearer's eyes; and a top coating disposed on the anti-radiation coating.

Clause 2. An eyeglass lens anti-radiation coating for providing protection against near infrared radiation damage to a wearer's eyes, the antiradiation coating comprising a layered structure having at least eight individual layers, wherein each layer of the layered structure comprises SiO₂, TiO₂, or ITO, the antiradiation coating being configured to reflect at least 40% of radiation in the near infrared region.

Clause 3. An eyeglass lens for providing protection against near infrared radiation damage to a wearer's eyes, the lens comprising: a polymeric base material; and an anti-radiation coating in the form of a layered structure that comprises: a first layer of a silicon or metal oxide having a thickness of at least 130 nm; a second layer of a metal oxide having a thickness of between about 1 nm and about 10 nm; a third layer of a silicon or metal oxide having a thickness of less than 80 nm; a fourth layer of a metal oxide having a thickness of at least 80 nm; a fifth layer of a silicon or metal oxide having a thickness of at least 150 nm; a sixth layer of a metal oxide having a thickness of at least 50 nm; a seventh layer of metal oxide having a thickness of between about 1 nm and about 10 nm; and an eighth layer of a silicon or metal oxide having a thickness of at least 40 nm; and a top coating disposed on the layered anti-radiation coating for protecting the layered structure, wherein a total thickness of the layered anti-radiation coating is at least 600 nm, and wherein the antiradiation coating being configured to facilitate transmission of visible light while reflecting radiation in the near infrared region for preventing passage thereof through the anti-radiation coating toward the wearer's eyes.

Clause 4. The eyeglass lens of any of the preceding Clauses, wherein, in order of layering, the first layer, the third layer, the fifth layer, and the eighth layer each comprise SiO₂.

Clause 5. The eyeglass lens of any of the preceding Clauses, wherein, in order of layering, the second layer, the fourth layer, and the sixth layer each comprise TiO₂.

Clause 6. The eyeglass lens of any of the preceding Clauses, wherein, in order of layering, the seventh layer comprises ITO.

Clause 7. The eyeglass lens of any of the preceding Clauses, wherein the layered structure is arranged with the first SiO₂ layer being nearest the polymeric base material in the fourth SiO₂ layer being farthest away from the polymeric base material.

Clause 8. The eyeglass lens of any of the preceding Clauses, wherein the anti-radiation coating reflects at least 40% of radiation within the near-infrared region.

Clause 9. The eyeglass lens of any of the preceding Clauses, wherein the anti-radiation coating reflects at least 50% of radiation within the near-infrared region.

Clause 10. The eyeglass lens of any of the preceding Clauses, wherein the anti-radiation coating reflects at least 60% of radiation within the near-infrared region.

Clause 11. The eyeglass lens of any of the preceding Clauses, wherein the anti-radiation coating permits transmission of at least 90% of rays within the visible spectrum.

Clause 12. The eyeglass lens of any of the preceding Clauses, wherein the anti-radiation coating permits transmission of at least 92% of rays within the visible spectrum.

Clause 13. The eyeglass lens of any of the preceding Clauses, wherein the anti-radiation coating permits transmission of at least 93% of rays within the visible spectrum.

Clause 14. The eyeglass lens of any of the preceding Clauses, wherein the first SiO₂ layer comprises a thickness of between about 130 nm to about 180 nm.

Clause 15. The eyeglass lens of Clause 14 or any of the preceding Clauses, wherein the first SiO₂ layer comprises a thickness of between about 145 nm to about 170 nm.

Clause 16. The eyeglass lens of Clause 15 or any of the preceding Clauses, wherein the first SiO₂ layer comprises a thickness of about 160 nm.

Clause 17. The eyeglass lens of any of the preceding Clauses, wherein the first SiO₂ layer comprises a refraction index of between about 1.25 to about 1.8.

Clause 18. The eyeglass lens of Clause 17 or any of the preceding Clauses, wherein the first SiO₂ layer comprises a refraction index of between about 1.3 to about 1.6.

Clause 19. The eyeglass lens of Clause 18 or any of the preceding Clauses, wherein the first SiO₂ layer comprises a refraction index of about 1.486.

Clause 20. The eyeglass lens of any of the preceding Clauses, wherein first TiO₂ layer comprises a thickness of between about 1 nm to about 50 nm.

Clause 21. The eyeglass lens of Clause 20 or any of the preceding Clauses, wherein the first TiO₂ layer comprises a thickness of between about 3 nm to about 10 nm.

Clause 22. The eyeglass lens of Clause 21 or any of the preceding Clauses, wherein the first TiO₂ layer comprises a thickness of about 6 nm.

Clause 23. The eyeglass lens of any of the preceding Clauses, wherein the first TiO₂ layer comprises a refraction index of greater than 1.0.

Clause 24. The eyeglass lens of Clause 23 or any of the preceding Clauses, wherein the first TiO₂ layer comprises a refraction index of greater than 1.5.

Clause 25. The eyeglass lens of Clause 24 or any of the preceding Clauses, wherein the first TiO₂ layer comprises a refraction index of greater than 1.7.

Clause 26. The eyeglass lens of any of the preceding Clauses, wherein the second SiO₂ layer comprises a thickness of between about 15 nm to about 60 nm.

Clause 27. The eyeglass lens of Clause 26 or any of the preceding Clauses, wherein the second SiO₂ layer comprises a thickness of between about 30 nm to about 40 nm.

Clause 28. The eyeglass lens of Clause 27 or any of the preceding Clauses, wherein the second SiO₂ layer comprises a thickness of about 33 nm.

Clause 29. The eyeglass lens of any of the preceding Clauses, wherein the second SiO₂ layer comprises a refraction index of between about 1.0 to about 1.9.

Clause 30. The eyeglass lens of Clause 29 or any of the preceding Clauses, wherein the second SiO₂ layer comprises a refraction index of between about 1.3 to about 1.6.

Clause 31. The eyeglass lens of Clause 30 or any of the preceding Clauses, wherein the second SiO₂ layer comprises a refraction index of about 1.5.

Clause 32. The eyeglass lens of any of the preceding Clauses, wherein second TiO₂ layer comprises a thickness of between about 60 nm to about 150 nm.

Clause 33. The eyeglass lens of Clause 32 or any of the preceding Clauses, wherein the second TiO₂ layer comprises a thickness of between about 90 nm to about 120 nm.

Clause 34. The eyeglass lens of Clause 33 or any of the preceding Clauses, wherein the second TiO₂ layer comprises a thickness of about 105 nm.

Clause 35. The eyeglass lens of any of the preceding Clauses, wherein the second TiO₂ layer comprises a refraction index of between about 1.0 to about 2.5.

Clause 36. The eyeglass lens of Clause 35 or any of the preceding Clauses, wherein the second TiO₂ layer comprises a refraction index of between about 1.7 to about 2.3.

Clause 37. The eyeglass lens of Clause 36 or any of the preceding Clauses, wherein the second TiO₂ layer comprises a refraction index of about 2.2.

Clause 38. The eyeglass lens of any of the preceding Clauses, wherein third SiO₂ layer comprises a thickness of between about 130 nm to about 180 nm.

Clause 39. The eyeglass lens of Clause 38 or any of the preceding Clauses, wherein the third SiO₂ layer comprises a thickness of between about 140 nm to about 160 nm.

Clause 40. The eyeglass lens of Clause 39 or any of the preceding Clauses, wherein the third SiO₂ layer comprises a thickness of about 150 nm.

Clause 41. The eyeglass lens of any of the preceding Clauses, wherein the third SiO₂ layer comprises a refraction index of between about 1.0 to about 2.0.

Clause 42. The eyeglass lens of Clause 41 or any of the preceding Clauses, wherein the third SiO₂ layer comprises a refraction index of between about 1.3 to about 1.7.

Clause 43. The eyeglass lens of Clause 42 or any of the preceding Clauses, wherein the third SiO₂ layer comprises a refraction index of about 1.5.

Clause 44. The eyeglass lens of any of the preceding Clauses, wherein third TiO₂ layer comprises a thickness of between about 50 nm to about 140 nm.

Clause 45. The eyeglass lens of Clause 44 or any of the preceding Clauses, wherein the third TiO₂ layer comprises a thickness of between about 75 nm to about 110 nm.

Clause 46. The eyeglass lens of Clause 45 or any of the preceding Clauses, wherein the third TiO₂ layer comprises a thickness of about 90 nm.

Clause 47. The eyeglass lens of any of the preceding Clauses, wherein the third TiO₂ layer comprises a refraction index of between about 1.5 to about 2.7.

Clause 48. The eyeglass lens of Clause 47 or any of the preceding Clauses, wherein the third TiO₂ layer comprises a refraction index of between about 1.9 to about 2.5.

Clause 49. The eyeglass lens of Clause 48 or any of the preceding Clauses, wherein the third TiO₂ layer comprises a refraction index of about 2.23.

Clause 50. The eyeglass lens of any of the preceding Clauses, wherein first ITO layer comprises a thickness of between about 1 nm to about 50 nm.

Clause 51. The eyeglass lens of Clause 50 or any of the preceding Clauses, wherein the first ITO layer comprises a thickness of between about 3 nm to about 10 nm.

Clause 52. The eyeglass lens of Clause 51 or any of the preceding Clauses, wherein the first ITO layer comprises a thickness of about 6 nm.

Clause 53. The eyeglass lens of any of the preceding Clauses, wherein the first ITO layer comprises a refraction index of between about 1.6 to about 2.5.

Clause 54. The eyeglass lens of Clause 53 or any of the preceding Clauses, wherein the first ITO layer comprises a refraction index of between about 1.8 to about 2.3.

Clause 55. The eyeglass lens of Clause 54 or any of the preceding Clauses, wherein the first ITO layer comprises a refraction index of about 2.055.

Clause 56. The eyeglass lens of any of the preceding Clauses, wherein fourth SiO₂ layer comprises a thickness of between about 30 nm to about 120 nm.

Clause 57. The eyeglass lens of Clause 56 or any of the preceding Clauses, wherein the fourth SiO₂ layer comprises a thickness of between about 50 nm to about 80 nm.

Clause 58. The eyeglass lens of Clause 57 or any of the preceding Clauses, wherein the fourth SiO₂ layer comprises a thickness of about 65 nm.

Clause 59. The eyeglass lens of any of the preceding Clauses, wherein the fourth SiO₂ layer comprises a refraction index of between about 1.1 to about 1.8.

Clause 60. The eyeglass lens of Clause 59 or any of the preceding Clauses, wherein the fourth SiO₂ layer comprises a refraction index of between about 1.3 to about 1.6.

Clause 61. The eyeglass lens of Clause 60 or any of the preceding Clauses, wherein the fourth SiO₂ layer comprises a refraction index of about 1.486.

Clause 62. The eyeglass lens of any of the preceding Clauses, wherein the lens is a prescription lens.

Clause 63. The eyeglass lens of any of the preceding Clauses, wherein the lens is a non-prescription lens.

Clause 64. The eyeglass lens of any of the preceding Clauses, wherein the anti-radiation coating is configured to reflect light in the wavelength range of about 700 nm to about 3000 nm.

Clause 65. The eyeglass lens of any of the preceding Clauses, wherein the anti-radiation coating is configured to reflect light in the wavelength range of about 700 nm to about 2500 nm.

Clause 66. The eyeglass lens of any of the preceding Clauses, wherein the anti-radiation coating is configured to reflect light in the wavelength range of about 780 nm to about 1600 nm.

Clause 67. The eyeglass lens of any of the preceding Clauses, wherein the anti-radiation coating is configured to reflect light in the NIR short-wavelength range of about 700 nm to about 1100 nm.

Clause 68. The eyeglass lens of any of the preceding Clauses, wherein the anti-radiation coating is configured to reflect light in the NIR long-wavelength range of about 1100 nm to about 2500 nm.

Clause 69. The eyeglass lens of any of the preceding Clauses, wherein the lens comprises a shape in the form of a shield.

Clause 70. The eyeglass lens of any of the preceding Clauses, wherein the lens comprises a pair of lenses.

Clause 71. The eyeglass lens of any of the preceding Clauses, wherein the lens comprises a secondary coating of a material selected from the group consisting of Al₂O₃, MgF₂, TiO₂, ZnO, fluoropolymers, CeO₂, Si₃N₄, SiC, SnO₂, ITO, ZrO₂, Ta₂O₅, Nb₂O₅, Y₂O₃, BaF₂, La₂O₃, MnO₂, Ag, Cu, Au, organic polymers, and their equivalents.

Clause 72. The eyeglass lens of any of the preceding Clauses, wherein one or more of the layers of the anti-radiation coating of a material selected from the group consisting of Al₂O₃, MgF₂, TiO₂, ZnO, fluoropolymers, CeO₂, Si₃N₄, SiC, SnO₂, ITO, ZrO₂, Ta₂O₅, Nb₂O₅, Y₂O₃, BaF₂, La₂O₃, MnO₂, Ag, Cu, Au, organic polymers, and their equivalents.

Clause 73. A method of forming an eyeglass lens having protection against near infrared radiation damage to a wearer's eyes, the method comprising forming a layered anti-radiation coating via the steps of: applying, to a polymeric base material, a first layer of a silicon or metal oxide having a thickness of at least 130 nm; applying, to the polymeric base material, a second layer of a metal oxide having a thickness of between about 1 nm and about 10 nm; applying, to the polymeric base material, a third layer of a silicon or metal oxide having a thickness of less than 80 nm; applying, to the polymeric base material, a fourth layer of a metal oxide having a thickness of at least 80 nm; applying, to the polymeric base material, a fifth layer of a silicon or metal oxide having a thickness of at least 150 nm; applying, to the polymeric base material, a sixth layer of a metal oxide having a thickness of at least 50 nm; applying, to the polymeric base material, a seventh layer of metal oxide having a thickness of between about 1 nm and about 10 nm; applying, to the polymeric base material, an eighth layer of a silicon or metal oxide having a thickness of at least 40 nm; and applying, to the polymeric base material, a top coating disposed on the layered anti-radiation coating for protecting the layered structure.

Clause 74. The method of Clause 73, wherein the forming the layered anti-radiation coating further comprises forming the layered anti-radiation coating to have a total thickness of at least 600 nm.

Clause 75. The method of any one of Clauses 73 to 74, wherein the layered anti-radiation coating is configured to facilitate transmission of visible light while reflecting radiation in the near infrared region for preventing passage thereof through the anti-radiation coating toward the wearer's eyes.

Clause 76. The method of any one of Clauses 73 to 75, wherein the anti-radiation coating filters at least 40% of radiation within the near-infrared region.

Clause 77. The method of any one of Clauses 73 to 76, wherein the anti-radiation coating filters at least 50% of radiation within the near-infrared region.

Clause 78. The method of any one of Clauses 73 to 77, wherein the anti-radiation coating filters at least 60% of radiation within the near-infrared region.

Clause 79. The method of any one of Clauses 73 to 78, wherein the anti-radiation coating permits passage of at least 90% of rays within the visible spectrum.

Clause 80. The method of any one of Clauses 73 to 79, wherein the anti-radiation coating permits passage of at least 92% of rays within the visible spectrum.

Clause 81. The method of any one of Clauses 73 to 80, wherein the anti-radiation coating permits passage of at least 93% of rays within the visible spectrum.

Clause 82. The method of any one of Clauses 73 to 81, wherein the lens is a prescription lens.

Clause 83. The method of any one of Clauses 73 to 82, wherein the lens is a non-prescription lens.

Clause 84. The method of any one of Clauses 73 to 83, wherein the anti-radiation coating is configured to reflect light in the wavelength range of about 700 nm to about 3000 nm.

Clause 85. The method of any one of Clauses 73 to 84, wherein the anti-radiation coating is configured to reflect light in the wavelength range of about 700 nm to about 2500 nm.

Clause 86. The method of any one of Clauses 73 to 85, wherein the anti-radiation coating is configured to reflect light in the wavelength range of about 780 nm to about 1600 nm.

Clause 87. The method of any one of Clauses 73 to 86, wherein the anti-radiation coating is configured to reflect light in the NIR short-wavelength range of about 700 nm to about 1100 nm.

Clause 88. The method of any one of Clauses 73 to 87, wherein the anti-radiation coating is configured to reflect light in the NIR long-wavelength range of about 1100 nm to about 2500 nm.

Clause 89. The method of any one of Clauses 73 to 88, wherein the lens comprises a shape in the form of a shield.

Clause 90. The method of any one of Clauses 73 to 89, wherein the lens comprises a secondary coating of a material selected from the group consisting of Al₂O₃, MgF₂, TiO₂, ZnO, fluoropolymers, CeO₂, Si₃N₄, SiC, SnO₂, ITO, ZrO₂, Ta₂O₅, Nb₂O₅, Y₂O₃, BaF₂, La₂O₃, MnO₂, Ag, Cu, Au, organic polymers, and their equivalents.

Clause 91. The method of any one of Clauses 73 to 90, wherein one or more of the layers of the anti-radiation coating of a material selected from the group consisting of Al₂O₃, MgF₂, TiO₂, ZnO, fluoropolymers, CeO₂, Si₃N₄, SiC, SnO₂, ITO, ZrO₂, Ta₂O₅, Nb₂O₅, Y₂O₃, BaF₂, La₂O₃, MnO₂, Ag, Cu, Au, organic polymers, and their equivalents.

### Further Considerations

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

As used herein, the term “about” is relative to the actual value stated, as will be appreciated by those of skill in the art, and allows for approximations, inaccuracies and limits of measurement under the relevant circumstances. In one or more aspects, the terms “about,” “substantially,” and “approximately” may provide an industry-accepted tolerance for their corresponding terms and/or relativity between items, such as a tolerance of from less than one percent to 10 percent of the actual value stated, and other suitable tolerances.

As used herein, the term “comprising” indicates the presence of the specified integer(s), but allows for the possibility of other integers, unspecified. This term does not imply any particular proportion of the specified integers. Variations of the word “comprising,” such as “comprise” and “comprises,” have correspondingly similar meanings.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the detailed description contains many specifics, these should not be construed as limiting the scope of the subject technology but merely as illustrating different examples and aspects of the subject technology. It should be appreciated that the scope of the subject technology includes other embodiments not discussed in detail above. In addition, it is not necessary for a device or method to address every problem that is solvable (or possess every advantage that is achievable) by different embodiments of the disclosure in order to be encompassed within the scope of the disclosure. The use herein of “can” and derivatives thereof shall be understood in the sense of “possibly” or “optionally” as opposed to an affirmative capability.

What is claimed is:

1. An eyeglass lens for providing protection against near infrared radiation damage to a wearer's eyes, the lens comprising:
a polymeric base material;
an anti-radiation coating disposed on the polymeric base material, the anti-radiation coating comprising a layered structure of a first SiO₂ layer, a first TiO₂ layer, a second SiO₂ layer, a second TiO₂ layer, a third SiO₂ layer, a third TiO₂ layer, a first ITO layer, and a fourth SiO₂ layer, the anti-radiation coating being configured to facilitate transmission of visible light while reflecting radiation in the near infrared region for protecting the wearer's eyes; and
a top coating disposed on the anti-radiation coating.

2. The eyeglass lens of claim 1, wherein the anti-radiation coating reflects at least 50% of radiation within the near-infrared region and permits transmission of at least 92% of rays within the visible spectrum.

3. The eyeglass lens of claim 1, wherein the first SiO₂ layer comprises a thickness of between about 145 nm to about 170 nm.

4. The eyeglass lens of claim 1, wherein the first SiO₂ layer comprises a refraction index of between about 1.3 to about 1.6.

5. The eyeglass lens of claim 1, wherein the first TiO₂ layer comprises a thickness of between about 3 nm to about 10 nm.

6. The eyeglass lens of claim 1, wherein the first TiO₂ layer comprises a refraction index of greater than 1.5.

7. The eyeglass lens of claim 1, wherein the second SiO₂ layer comprises a thickness of between about 30 nm to about 40 nm.

8. The eyeglass lens of claim 1, wherein the second SiO₂ layer comprises a refraction index of between about 1.3 to about 1.6.

9. The eyeglass lens of claim 1, wherein the second TiO₂ layer comprises a thickness of between about 90 nm to about 120 nm.

10. The eyeglass lens of claim 1, wherein the second TiO₂ layer comprises a refraction index of between about 1.7 to about 2.3.

11. The eyeglass lens of claim 1, wherein the third SiO₂ layer comprises a thickness of between about 140 nm to about 160 nm.

12. The eyeglass lens of claim 1, wherein the third SiO₂ layer comprises a refraction index of between about 1.3 to about 1.7.

13. The eyeglass lens of claim 1, wherein the third TiO₂ layer comprises a thickness of between about 75 nm to about 110 nm.

14. The eyeglass lens of claim 1, wherein the third TiO₂ layer comprises a refraction index of between about 1.9 to about 2.5.

15. The eyeglass lens of claim 1, wherein the first ITO layer comprises a thickness of between about 3 nm to about 10 nm.

16. The eyeglass lens of claim 1, wherein the first ITO layer comprises a refraction index of between about 1.8 to about 2.3.

17. The eyeglass lens of claim 1, wherein the fourth SiO₂ layer comprises a thickness of between about 50 nm to about 80 nm.

18. The eyeglass lens of claim 1, wherein the fourth SiO₂ layer comprises a refraction index of between about 1.3 to about 1.6.

19. The eyeglass lens of claim 1, wherein the anti-radiation coating is configured to reflect light in the NIR long-wavelength range of about 700 nm to about 2500 nm.

20. The eyeglass lens of claim 1, wherein the lens comprises a secondary coating of a material selected from the group consisting of Al₂O₃, MgF₂, TiO₂, ZnO, fluoropolymers, CeO₂, Si₃N₄, SiC, SnO₂, ITO, ZrO₂, Ta₂O₅, Nb₂O₅, Y₂O₃, BaF₂, La₂O₃, MnO₂, Ag, Cu, Au, organic polymers, and their equivalents.
